(19) United States
(12) Patent Application Publication
(10) Pub. No.: US 2010/0177253 A1
(43) Pub. Date: Jul. 15, 2010

(54) COHERENT IMAGING METHOD OF LASER PROJECTION AND APPARATUS THEREOF

(76) Inventor: Michael GOLUB, Rehovot (IL)

Correspondence Address: The Law Office of Michael E. Kondoudis, 888 16th Street, N.W., Suite 800, Washington, DC, 20006, US

(21) Appl. No.: 12/669,056

(22) PCT Filed: Jul. 17, 2008
(86) PCT No.: PCT/IL08/00991

§ 371 Date: Jan. 14, 2010

(51) Int. Cl. G02F 1/1335; F21V 5/00; F21V 9/16; G03B 21/14

(52) U.S. Cl. 349/8; 362/235; 362/231; 353/38; 353/30; 353/121

(57) ABSTRACT

A coherent light source system is presented. The system comprises at least one coherent light emitter producing a coherent light beam, a focusing lens unit, and a beam shaper unit, the beam shaper unit being accommodated between the coherent light emitter and the collimating lens unit being in a front focal plane of the focusing lens unit, thereby providing a substantially uniform profile and high-degree collimation at a desired plane in an optical path of light propagation.

### CROSS-REFERENCE TO RELATED APPLICATIONS

This application is a National Phase of International Patent Application No. PCT/IL2008/000991, filed Jul. 17, 2008, which claims the benefit of priority from U.S. Provisional Patent Application No. 60/950,141, filed 17 Jul. 2007.

### FIELD OF THE INVENTION

The present invention relates generally to projection systems using laser sources and electro-optical spatial light modulators (SLM), e.g. liquid crystal panels.

### BACKGROUND OF THE INVENTION

Image projection systems are the essential part of computers, television and cinema systems. Compact projection systems help to display in a user friendly form, the digital contact tapped inside laptop and desktop computers, cellular phones, or compact memory devices. The use of coherent laser sources in an image projection system is disclosed for example in the U.S. Pat. No. 6,494,371. A scanning Red-Green-Blue (RGB) laser beam system is disclosed for example in U.S. Pat. No 6,000,801, and No. 5,774,174. Several types of solid-state semiconductor lasers can be used for input to available light combiners and to a conventional scanner as described for example in U.S. Pat. No. 5,317,348.

Comparatively to incoherent light sources, laser sources provide a higher brightness, high concentration of light power in angular directions of light propagation, a large depth of focus for a projected image, and an efficient electrical to optical conversion. However, laser provides spatially coherent light which requires special treatment in optical systems design. Moreover, the colors have to be created by separate laser sources. The combination of these laser sources, as well as the combination of the spatial modulation of each laser source in the projected image, are both critical for the entire projection system.

The spatial modulation for each color may be combined as follows: a three-panel projection system can make use of a separate SLM per each color. However, the fitting of the pixel grid of several SLM on the projected image is a difficult task. Alternatively, single-panel projection systems can make use of a single SLM for all the colors, using a time sequential modulation of the SLM. However, these types of systems suffers from high frequency of pixel control in the SLM modulation, not supported by SLM conventionally associated with liquid crystal panels (LCs). Also, the maximum power of the laser sources of these systems is used for only part of the video frame duration, inducing an overall reduction of the image brightness. Another approach is to split each SLM pixel to three sub-pixels and, accordingly, split the incident light to three separate sub-beams. Projection systems associated with white light and using diffraction gratings for splitting the incident light to three separate sub-beams are disclosed for example in U.S. Pat. No. 5,615,024, No. 6,392,806 and No. 5,894,359.

To obtain separate colors separated on different sub-pixels of a single parallel color SLM, light beams of different colors propagating in different directions may also be used. In order to minimize the crosstalk between pixels, the laser source corresponding to each single pixel is focused on a liquid crystal cell by a lenslet of the microlens array. However, natural divergence of lasers and inherent diffraction limit are preventing the beam corresponding to each single pixel to be sharply focused. The focal spot of the three colors can overlap, inducing a limitation to the reduction in the pixel size of SLMs. In order to avoid overlap of spots with different colors, SLMs with pixel split to three sub-pixels corresponding to three colors should be exploited.

U.S. Pat. No. 6,295,107, No. 5,398,125 and U.S. Pat. No. 5,508,834 disclose liquid crystal panels having one or more microlens arrays, cascaded on one or both sides of the projection panel and focusing the beams inside or beyond the liquid crystal layers. The pair of cascaded microlens array is used for focusing and then for the re-collimation of a beamlet corresponding to the lenslet. However, using different direction of propagation for the three colors, only a part of the light focused by the lenslet of the first lenslet array, reaches the aperture of the second lenslet array.

Various configurations of the SLM-based projection systems are disclosed in WO 04/064410, WO 04/084534, U.S. Pat. No. 7,128,420, WO 07/060666, WO 05/036211 and WO 08/010219, all assigned to the assignee of the present application.

### GENERAL DESCRIPTION

The present invention provides a coherent light source system, particularly for use in an image projection system. The coherent light source system comprises a coherent light emitter (e.g. laser) producing a coherent light beam, a collimating lens unit, and a beam shaper unit accommodated between the coherent light emitter and the collimating lens unit being in a vicinity of a front focal plane of the collimating lens unit downstream of said front focal plane, thereby providing a substantially uniform profile and high-degree collimation at a desired plane in an optical path of light propagation.

Such configuration of the coherent light source system allows for producing a laser beam that features essentially single local beam direction (ray) per point in a beam cross section and spatial coherence in successive cross sections along the beam propagation axis. The numerical aperture (NA) of a local beam direction (ray) per point in a beam cross section may be in the range from 0.01 up to 0.05.

Thus according to another aspect of the invention, it provides an imaging method comprising generating a coherent light beam having essentially single local beam direction per point in a beam cross section and spatial coherence in successive cross sections along the beam propagation axis.

The image projection system according to the invention thus comprises the above described light source system (a coherent light emitter, a beam shaper and a collimator), a spatial light modulator (SLM) unit defining an active surface formed by a pixel arrangement, a focusing microlens arrangement accommodated in the optical paths of light output from the light source system and propagating towards the active surface of the SLM unit, and an image projection optics accommodated at the light output of the SLM unit. It is important feature of the invention that the microlens arrangement have a pitch corresponding to a group of SLM subpixels which is larger than a single SLM pixel and contains a number of the subpixels corresponding to the number of primary colors, for example to the RGB or to the RGBW etc.

It should be noted that the focusing microlens arrangement may include microlens array(s) inside the SLM unit (i.e. within the SLM layer structure in between enclosing substrates (typically glass substrates) and/or microlens array(s) external to the SLM unit. Incorporation of microlens arrays in the SLM unit is described in various patent publications of the same assignee. Also, it should be noted that the projection system may include additional focusing/collecting/directing elements (e.g. lenses) located upstream and/or downstream of the beam shaper with respect to the light propagation through the system.

The image projection optics may be a projection lens configured and operable to use the spatially coherent properties of the laser beam(s).

The SLM may be controlled by digital data of a digital hologram of an image required to be projected on the screen. Operation with a coherent light emitter (laser) advantageously allows for utilizing Fourier holograms, with polarization or with phase modulation. Using polarization or phase modulation improves the efficiency by redistribution, rather than blocking part of the light by a cross polarizers pair. The projection lens may implement Fourier Transform of the light distribution created by the SLM. The use of such a holograms option is based on that spatial modulation of phase or polarization might result in intensity modulation, provided the modulated light is allowed to propagate some distance in free space.

The beam shaper of the present invention is configured and operable to affect the intensity profile of a light beam emitted by the coherent light emitter to provide a light beam of a substantially rectangular uniform intensity profile on the SLM plane. The beam shaper may be implemented as a refractive asymmetrical micro-beam-shaper, or alternatively as a diffractive element, preferably designed as a top hat element.

The coherent light source system of the present invention may comprise a plurality of coherent emitters (e.g. lasers) producing light of different wavelengths corresponding to different color components of the image being projected. The separate emitter may be configured and operable to produce light in the form of a plurality of spatially separated light beams. The projection system, configured for projecting a colored image, may include multiple SLMs in the optical paths of multiple light components, or a common SLM for more than one color component.

In some embodiments, the SLM is configured as an integrated multilayer structure comprising a liquid crystal pixel matrix configured and operable for spatially modulating light passing therethrough. The SLM may be of a transmitting type (having light input and output at opposite sides (glass substrates) of the SLM unit) or of a reflective type (having light input and output at the same side of the SLM unit). The SLM may be associated with, and/or preferably comprise at its integral part, at least one focusing microlens array (MLA) placed in front of the SLM and configured such that every pixel of the pixel matrix is associated with its corresponding microlens from the MLA.

The MLA may have a curved surface defining an array of convex or concave surface regions of the microlens in the MLA, respectively, and an opposite planar surface which is common for all the microlenses in the MLA. The MLA may be spaced by either one of its surface from an active surface of the pixel matrix. The SLM may be configured and operable for focusing input light beams of different incident directions onto spaced-apart spots, respectively, within the same pixel by the corresponding microlens of the focusing MLA.

The dimension of the lenslet of the MLA may be substantially equal to the dimension of the pixel.

In some embodiments, the pixel matrix of the SLM may be arranged in a group of sub-pixels (each and every one of the pixels is therefore split to a group of sub-pixels (e.g. three)) and the separated light beams of the coherent light emitter are focused towards each sub-pixel using the focusing MLA. The focusing MLA has a pitch that covers a group of the sub-pixels such that the light beams of different colors, incident on the SLM at different incident angles, are focused on different SLM sub-pixels corresponding to different colors, such that each sub-pixel separately controls a single color component.

The projection system of the present invention may comprise a field MLA accommodated in the focal plane of the focusing MLA such that the optical power of the field MLA is essentially the same as the optical power of the focusing MLA. The directions of the focused beam propagation may be brought to substantially parallel beams to the optical axis by using the field MLA. The spacing between the focusing MLA and the field MLA is selected to be substantially equal to the focal length of the focusing MLA. The focal length of the field MLA and the focal length of the focusing MLA may be substantially equal.

In some embodiments, the laser beams of different colors may have different incidence angles towards the SLM. The different incident angles of the different colors may be created by using appropriately oriented wavelength-selective filters (e.g. tilted dichroic mirrors) placed before the SLM. Alternatively, a diffraction grating may be used to create different incident angles of the different colors. The diffraction grating may be accommodated in proximity to the focusing MLA and configured with a period providing light beam separation within the dimensions of the clear aperture of the pixel of the SLM.

### BRIEF DESCRIPTION OF THE FIGURES

In order to understand the invention and to see how it may be implemented in practice, and by way of non-limiting example only, with reference to the accompanying drawing, in which:

FIGS. 1A-1C schematically illustrate a ray tracing of incoherent (FIG. 1A) and coherent imaging (FIGS. 1B-1C);

FIGS. 2A-2B schematically illustrate the beam divergence and ray fans of incoherent (FIG. 2A) and coherent imaging (FIG. 2C);

FIGS. 3A-3C illustrate three examples of an optical scheme in a laser projection system of the invention utilizing a single modal coherent laser light emitter associated with a beam shaping unit and a collimating unit, for a Diode-Pumped (DPM) laser emitting a diverging beam (FIGS. 3A, 3B), and for a diode laser (FIG. 3C);

FIG. 4 schematically illustrates an optical scheme of an example of an LC panel-based laser projection system;

FIG. 5A illustrates an SLM having an angular separation of colors using a focusing microlens array in coherent imaging;

FIG. 5B illustrates an SLM having an angular separation of colors using a focusing microlens array and field microlens array in coherent imaging;

FIGS. 5C and 5D exemplify relative accommodation of different colors in three-color (FIG. 5C) and four-color (FIG. 5D) laser units; and;

FIGS. 5E-5F illustrate an example of corresponding images obtainable on three (FIG. 5E) and four (FIG. 5F) spots corresponding to adjacent pixels on the SLM's pixel arrangement.

### DETAILED DESCRIPTION OF PREFERRED EMBODIMENTS

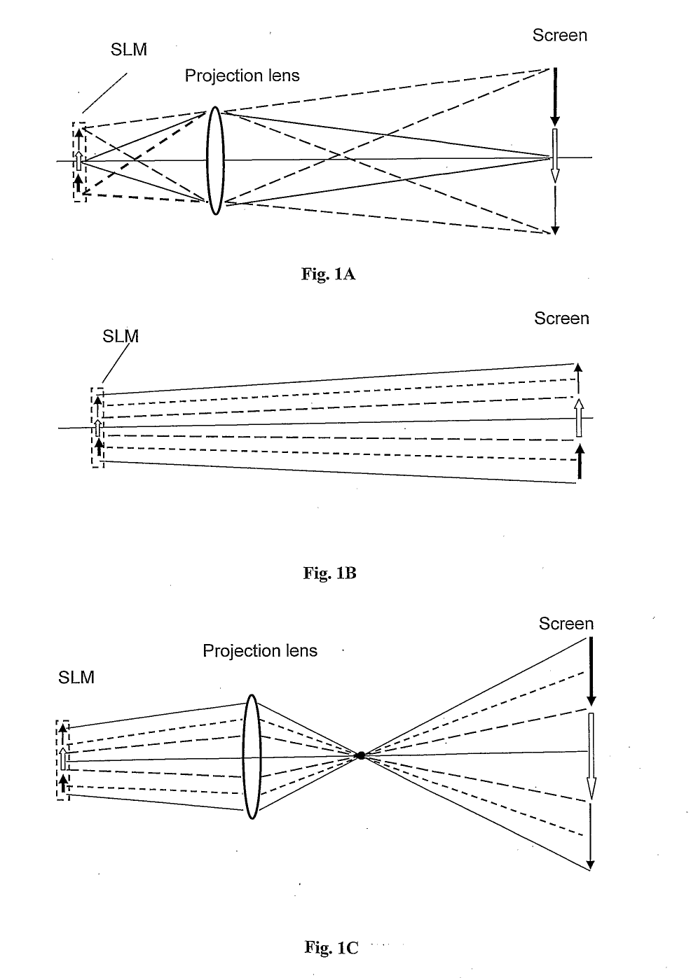

The projection system of the present invention uses the advantages of coherent imaging. The use of a spatially coherent light source in a projector, especially micro-projector, allows for improving a directional projection of images as compared with that obtainable with using the conventional incoherent projection systems. In this connection, reference is made to FIGS. 1A to 1C FIGS. 1A-1C, illustrating a light propagation scheme for incoherent and coherent imaging setups.

In FIG. 1A, an object illuminated by incoherent light is imaged onto a screen using a projection lens. As illustrated, every point of the object produces a wide fan of many rays inducing a projection system having high resolution in incoherent imaging. In A system illuminated by a coherent light is commonly unable to provide a wide fan of rays but features interaction between adjacent points of the coherent light image. In a lenslet imaging with coherent light (e.g. geometrical coherent imaging), as illustrated in FIG. 1B, a single ray is produced from every point of the object and the image is geometrically transferred from the object to the screen. However, resolution of the image will be limited in this case by diffraction effects on the fine details of the object. Comparatively, lens assisted coherent imaging, illustrated in FIG. 1C produces a single ray or a limited fan of rays from every point of the object, but each point performs incoherent match with adjacent points and therefore inducing a system with higher resolution compared to the system of FIG. 1B.

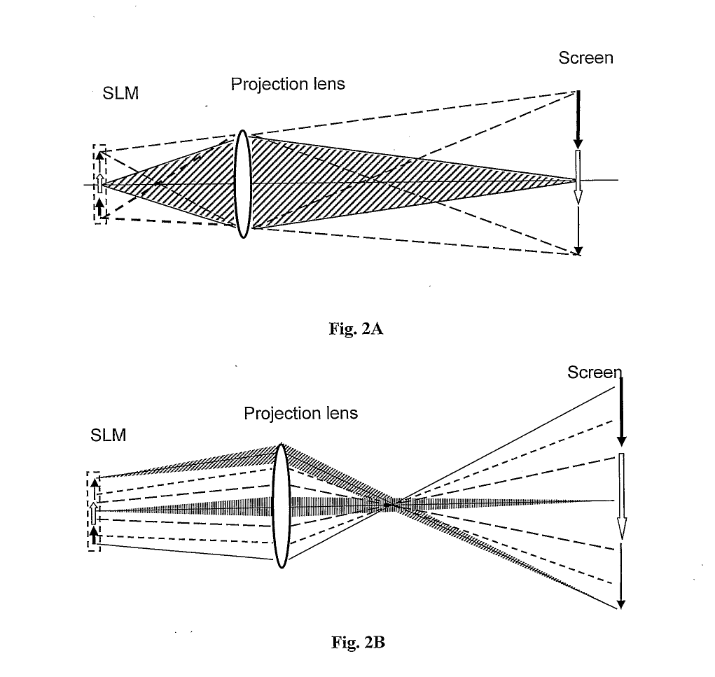

Reference is made to FIGS. 2A-2B exemplifying a light propagation scheme of a conventional projection image system. Here, FIG. 2A illustrates a projection system using incoherent imaging and FIG. 2B illustrates the use of coherent imaging. As illustrated, the beam divergence emerging from the projection lens using incoherent imaging is high comparatively to coherent imaging, however each image point is formed by a continuous set of adjacent object points and consequently a high image resolution is available, even though the fan of rays in each object point is limited in angular width.

Let's assume that an object on a spatial light modulator panel is described by a complex amplitude function wₒ (xₒ), in a case of coherent imaging, or by an intensity function Iₒ(xₒ), in a case of incoherent imaging, where xₒ=(xₒ,yₒ)are the 2D Cartesian object coordinates in the object plane, and wₒ(xₒ)and Iₒ(xₒ) depend on the wavelength λ. The projection imaging system transfers the 2D object with coordinates xₒ to an image having enlarged 2D Cartesian image coordinates x=(x, y), in accordance with a geometrical magnification coefficient V, such as:

x=Vxₒ (1)

An “ideal image” ŵ(x), Î(x) is described by new 2D Cartesian image coordinates x=(x, y) such that:

$$\hat{w} ( x ) = {w}_{o} ( \frac{x}{V} ) , \hat{I} ( x ) = {I}_{o} ( \frac{x}{V} ) . \qquad ( 2 )$$

Let's assume that the projection lens has a point spread function (PSF) h(x) and h_{I}(x), respectively for coherent and incoherent illumination. The actual image I(x) is a convolution of the ideal image Î(x) with h(x) such that:

w(x)=∫h(x−x′)ŵ(x′)d²x′, (3)

I(x)=∫h(x−x′)Î(x′)d²x′, (4)

for coherent and incoherent imaging respectively, where:

h^{I}(x′)=|h(x′)|²

Coherent imaging depends substantially on the spatial frequency content of the object, mathematically described by a Fourier Transform of the complex amplitude function, as:

W(v)=∫w(x)exp(−i2πv·x)d²x (5)

Spatial frequency variable v is defined in a free space with depth z as:

$$v = \frac{u}{λ z} , \qquad ( 6 )$$

and with a lens having a focal length F as:

$$v = \frac{u}{λ F} \qquad ( 7 )$$

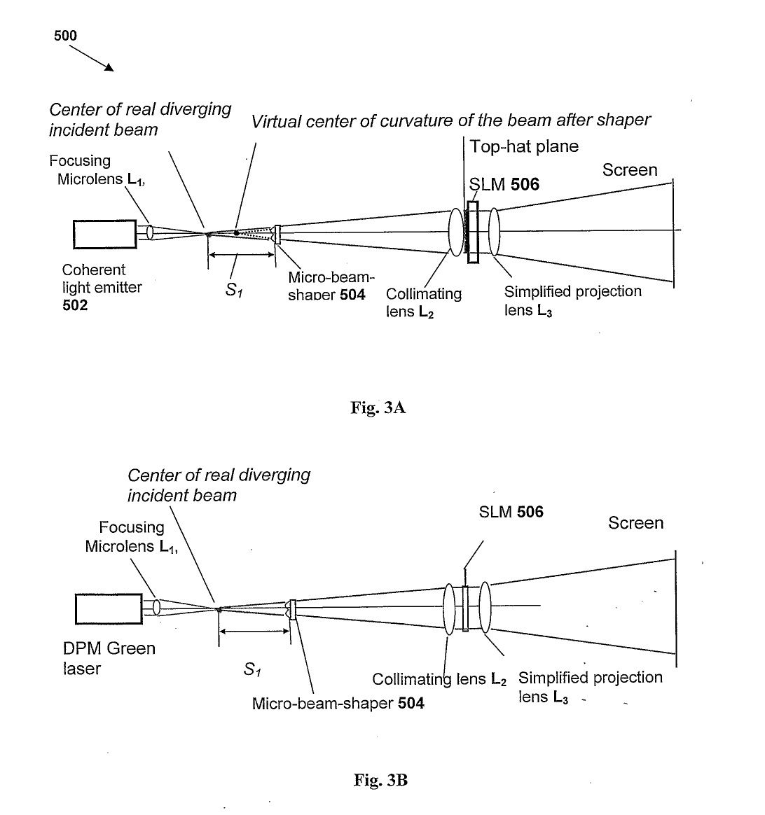

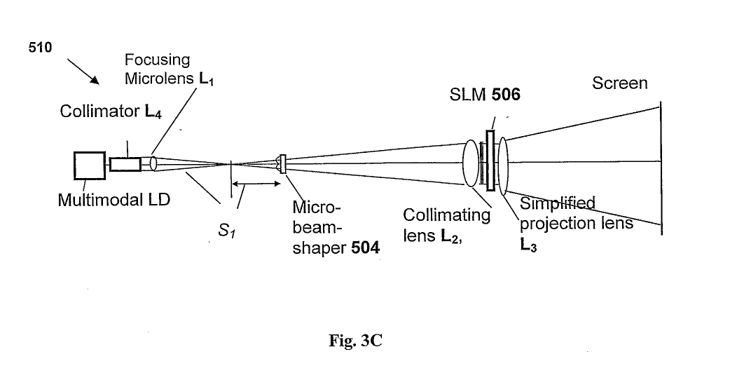

Reference is made to FIGS. 3A-3C exemplifying optical schemes for a laser projection system of the invention utilizing a light source system including a coherent light emitter, a beam shaping unit and a collimating unit.

FIG. 3A shows a projection system 500 which comprises a coherent light source system including a coherent light emitter 502 (such as a diode laser or a green DPM laser), a beam shaper (micro-beam shaper) 504, and a collimating lens L₂ (for example having a focus of 22.5/27/45 mm). The beam shaper is located at a small distance after (downstream) a front focal plane of L₂. System 500 further includes an SLM 506 configured and operable for spatially modulating light passing therethrough and includes a simplified projection lens L₃. Also optionally provided in system 500 is a microlens L₁ accommodated at the output of emitter 502, upstream of the beam shaper 504 (with respect to a direction of light propagation through the light source system). Lens L₁ is configured and operable to generate a substantially parallel illumination, for example having a focus of 1.1 mm/2.5 mm on the x, y plane). Beam shaper 504 is configured and operable to generate a uniform intensity distribution within the cross-section of the light beam incident on the SLM. Further provided in system 500 is a projection lens (not shown here) configured and operable to create an appropriately magnified image of the active pixels of the SLM and project it onto a projection target (e.g. a single lens having for example a focus of 6/9/18 mm).

The beam shaper 504 may be implemented as a diffractive element (commonly referred to as “diffractive top-hat beam shaper”) or alternatively as a refractive micro-optical element (commonly referred to as “refractive top-hat micro-beam-shaper”) operable to modify the beam intensity distribution to produce the substantially uniform intensity distribution of the beam within its cross-section. The beam shaper 504 is placed between the coherent light emitter 502 and the collimating lens L₂, more specifically being placed in the vicinity and downstream of the front focal plane of the collimator. The beam shaper may be a substrate on which complex microstructures are created to modulate and transform an incident wave into a predetermined pattern through diffraction. The beam shaper can utilize a multi-pixel diffractive optical phase mask (filter) or fractal approach based phase mask, when lit with a coherent light source system, can be designed to output a two-dimensional array of spots with equal energetic distribution. The beam shaper is configured and operable to control the diffraction of incident light by modifying wavefronts through the use of interference and phase control. As a light beam goes through the beam shaper, the properties of the beam (the phase and/or the amplitude) are changed according to the principles of optics. The modified outgoing light beam produces a certain intensity pattern on the image plane in either the near field or the far field of the beam shaper. Using the system of the present invention enables to obtain at the output plane, a top-hat intensity having given dimensions and a nearly spherical wavefront at a predetermined distance S₁ (for example of about 45 mm) from the shaper. The predetermined distance is estimated from the collimation condition of the collimating lens L₂. For a given beam diameter and divergence before lens L₁, the distance S₁ should be optimized to have a producible shaper, i.e. smaller slope and smaller sag.

The beam shaper may be configured and operable to correct the wavefront of the beam to improve the collimation. It should be a refractive or diffractive element having an aspherical surface of a non-symmetrical shape.

As indicated above, the beam shaper is placed downstream of the front focal plane of the collimating lens L₂ and close to said focal plane, thus enabling to obtain a beam having a uniform profile (instead of a Gaussian profile produced by the laser sources) and a high degree of collimation at a desired plane (the so-called “top hat plane”). The input surface of the SLM unit is located in or very close to said plane.

It should be also noted that the alignment of the system elements and the tolerances of the laser parameters are to be taken into consideration. The laser tolerances may be compensated by optimizing a distance from the microlens L₁ to the beam shaper 504. A distance from the focus of the microlens L₁ to the beam shaper 504 may also be optimized to obtain an output beam with the desired “top-hat” intensity and nearest-to-spherical wavefront at a predetermined distance from the beam shaper 504.

As shown in FIG. 3A in a self-explanatory manner, the shaper 504 actually “displaces” the center of the real diverging incident beam to a virtual center of curvature of the beam.

In other embodiments, the optical system may include a 90° C. Twisted Nematic (TN) SLM, which rotates the beam polarization up to 90° C. Different pixels of a spatially modulated light feature different polarization. The coherent light passing through the SLM undergoes diffraction while propagating towards an intermediate image plane located at a predetermined distance (about 1 mm) after the active surface (liquid crystal layer) of the SLM. The diffraction process redistributes the light in between bright and dark pixels instead of blocking (i.e. absorbing) the light in dark pixels. The projection lens (at the output of the SLM) images the intermediate image plane onto the screen rather than the active surfrace. The picture in the intermediate image plane may be an encoded version of the picture in the liquid crystal layer. A Pre-encoding may be performed by a digital processing of the video signal. A digital filter might be of a sliding window type, with a buffer of several pixels or few rows of pixels. This configuration enables to eliminate the need of using polarizer(s), and together with the redistribution process of the light instead of absorption, lead to an optical power saving of about 2.5, including 2 times from the dark-bright re-distribution and 1/0.8=1.25 times from the elimination of the polarizer(s).

FIG. 3B shows configuration of the projection system of the present invention in which SLM may be a transmissive liquid crystal microdisplay (for example Quarter Video Graphics Array (QVGA), i.e. a computer display with 320×240 resolution associated with a video controller or a Video Graphics Array (VGA), i.e. a computer display with 640×480 resolution associated with a video controller). Here, the light emitter is as a DPM Green laser. This system is generally similar to the above described system 500, but makes use of a collimated beam of the DPM laser rather than a diverging in slow and axis beam of the diode laser as was depicted in the FIG. 3A.

FIG. 3C shows yet another configuration of the projection system, generally designated 510, of the present invention. In the system, a coherent light source system includes a multimodal Laser Diode (constituting a coherent light emitter). The system is generally similar to the above-described system 300 but includes an additional collimator L₄ at the output of the laser diode upstream of the microlens L₁. This is because of the high divergence of light produced and a long (usually 10-200 micrometer) length of the emitter area typical for a multimodal laser diode, a collimator of fast and slow axis is required in addition to the microlens L₁.

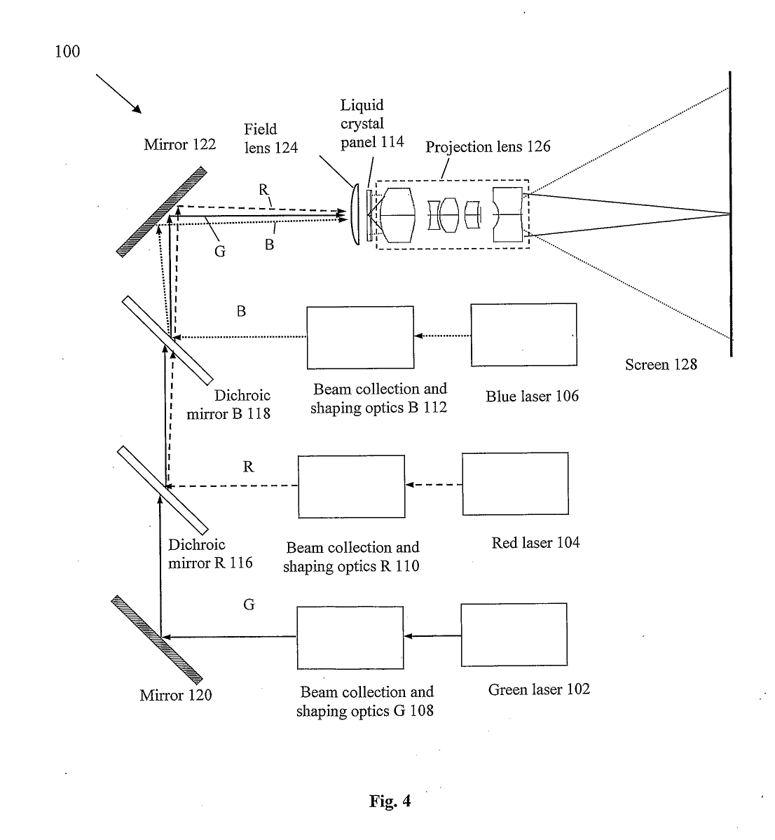

Reference is made to FIG. 4 representing an example of a laser projector system, generally designated 100. The system 100 comprises a coherent light source system including a green laser 102, a red laser 104, and a blue laser 106, a beam collection and shaping optics unit comprising three beam shapers 108, 110, 112 associated with the three light emitters respectively, configured and operable to convert the Gaussian laser beams to substantially collimated beams having a uniform intensity profile. Further provided in system 100 is an SLM unit (e.g. a liquid crystal panel) 114 configured and operable for spatially modulating light passing therethrough, a field lens 124 placed in front of the liquid crystal panel 114 and operating to provide a substantially parallel illumination, and a projection lens 126 projecting a magnified image of the active pixels of the LC panel 114 on the screen 128. Further provided in the system are various light collecting/focusing/directing elements. The latter, in the present example, include wavelength-selective filters (e.g. dichroic mirrors) 116, 118 and light deflectors (mirrors) 120, 122 appropriately accommodated and operating together for combining light beams from the three lasers into a single combined beam with mutual angular separation between the red, green and blue light components.

As shown in FIG. 4 in a self-explanatory manner, R, G, and B light components 104, 102 and 106 are generated by three laser sources, respectively, e.g., compact laser diodes with appropriate powers, in order to get a white source. The spatially modulated R,G,B 104, 102 and 106 are then combined by a set of dichroic mirrors 116, 118 and mirrors 120, 122 into a combined beam that passes through imaging field lens 124, and the so-produced output beam is projected onto screen surface 128, where the output image appears.

The direction of the optical axes of the R,G,B laser channels and the angular orientation of the dichroic mirrors 116, 118 may be adjusted so to have a small angle between the R,G,B light beams when being incident onto the liquid crystal panel 114.

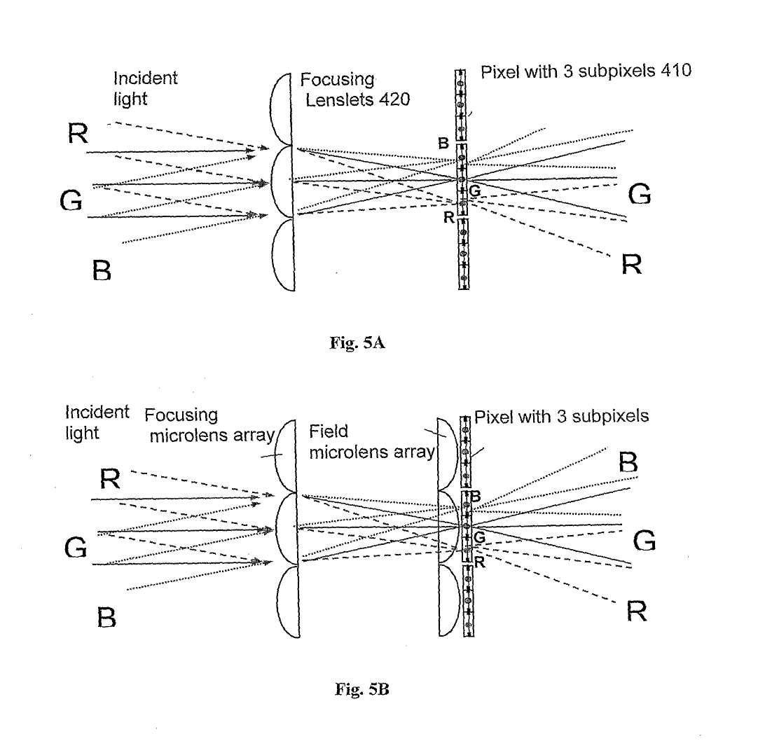

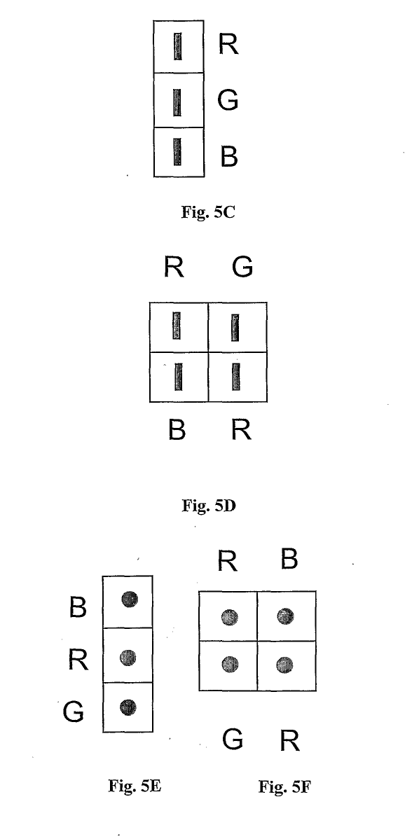

Reference is made to FIG. 5A illustrating a partial view of an example of an SLM. The latter comprises a focusing lenslets 420 (e.g. focusing microlens array) for focusing beamlets of the RGB channels into small spots on the active surface/plane of the SLM (e.g. LC panel, LCOS panel, DLM mirrors). The active surface is that of a pixel assembly/matrix location. Generally, the lenslet assembly 420 includes one or more lenslet arrays accommodated at least upstream of the pixel assembly with respect to the direction of propagation of incoming light. The lenslet array 420 may be a two-dimensional array of small lenses, useful in piece-wise condensing the incoming light beam. Each of the lenses may be optically designed to focus a corresponding light portion of the input beam that impinges on the lens into a small area around the lens' axis, at a distance of a few microns (e.g., 12-15 microns) from the lenslet array. The pitch of the lenslet array is designed to condense the incoming light to match the pitch of the active pixel array (e.g. a group of pixels forming sub-pixel). The lens may be of a square shape, so that the lenses are tangent to each other and fill most of the lens array area (fill factor approximately 100%). The lenses can also be of a circular shape. The optical characteristics of the lens and the distance between the lens and the active pixels are calculated by simple optical methods, to ensure that the diameter of the beamlet spot on the active pixel plane is smaller than the aperture defined by the pixel, thus all the light impinging onto the LC pixel arrangement passes through the active area of the pixel assembly.

In some embodiments, the LC panel includes a focusing microlens array (MLA) and a field MLA accommodated in a spaced-apart relationship in an optical path of light passing through the LC panel towards the active surface of the pixel matrix. The configuration may be such that the planar surfaces of the focusing and field MLAs are spaced from one another by the first spacer layer structure, and a curved surface of the field MLA is located close to the active surface of the pixel matrix.

It should be noted that the present invention provides an image projection system operable with different colors, and separately spatially modulated by sub-pixels of the common pixel aperture. The reduction of the pixel size towards the sub-pixel size is achieved by exploiting a microlens arrays and an additional field microlens arrays.

In this connection, reference is made to FIG. 5B representing a cross-sectional view of a liquid crystal panel 1014 with focusing microlens array 400 and field microlens array 402. The focusing microlens array 400 focuses the beamlet into a small spot at the active plane of the liquid crystal which passes without obscuration through the pixel aperture. The field microlens array 400 changes the direction of propagation of each of the R,G,B beams into substantially parallel beams to the optical axis of the projection lens 1026. This configuration produces diverging beams after the liquid crystal panel. The LC panel is configured and operable as an SLM unit having an LC-based pixel unit, which includes an array of spaced-apart pixels or pixel apertures 404.

Reference is made to FIGS. 5C-5F representing different angular arrangements of the laser source as seen from the side of the SLM (5C-5D) and the corresponding location of focused spots of different wavelengths at the subpixels corresponding to a single pixel of the SLM (5E-5F).

1. A coherent light source system, comprising at least one coherent light emitter producing a coherent light beam, a focusing lens unit, and a beam shaper unit, the beam shaper unit being accommodated between the coherent light emitter and the collimating lens unit being in a front focal plane of the focusing lens unit, thereby providing a substantially uniform profile and high-degree collimation at a desired plane in an optical path of light propagation.

2. The system of claim 1, wherein said beam shaper unit comprises at least one diffractive beam shaping element.

3. The system of claim 2, wherein said beam shaper unit comprises a diffractive top-hat element.

4. The system of claim 1, wherein said beam shaper unit comprises a refractive asymmetrical micro-beam-shaper.

5. The system of any one of the preceding claims, wherein said coherent light source system comprises a plurality of coherent light emitters producing light beams of different wavelengths.

6. An image projection system comprising the coherent light source system of any one of the preceding claims, and comprising a spatial light modulator (SLM) unit defining an active surface formed by a pixel arrangement, a focusing microlens array arrangement accommodated in the optical path of light output from the light source system and propagating towards the active surface of the SLM unit, and an image projection optics accommodated at the light output of the SLM unit.

7. The system of claim 6, wherein the light source system is configured and operable to produce light in the form of a plurality of spatially separated light beams.

8. The system of claim 6 or 7, comprising at least one focusing microlens array assembly accommodated in the optical paths of the emitted light.

9. The system of claim 8, wherein said at least one focusing microlens array assembly is located inside the SLM unit.

10. The system of claim 9, wherein said SLM is configured as an integrated multilayer structure comprising a liquid crystal pixel matrix configured and operable for spatially modulating light passing therethrough, said SLM comprising said at least one focusing microlens array (MLA) placed in front of said pixel matrix and configured such that every pixel of the pixel matrix is associated with its corresponding microlens from said at least one MLA, the SLM being configured for focusing input light beams of different incident directions onto spaced-apart spots, respectively, within the same pixel by the corresponding microlens of the focusing MLA.

11. The system of claim 10, wherein a dimension of the lenslet of said MLA is substantially equal to the dimension of the pixel.

12. The system of claim 10 or 11, wherein said pixel matrix is arranged in a group of sub-pixels, separated light beams of different wavelength produced by the light source system being focused towards each sub-pixel; and said focusing MLA has a pitch that covers a group of said sub-pixels such that said light beams of different wavelengths are incident on said SLM at different incident angles are focused on different sub-pixels corresponding to different wavelengths, such that each sub-pixel separately controls a single wavelength component.

13. The system of claim 12, wherein said different incident angles of said different wavelengths are created by using tilted dichroic mirrors placed in front of said SLM.

14. The system of claim 12, wherein said different incident angles of said different wavelengths are created by a diffraction grating accommodated in proximity to said focusing MLA having a period providing light beam separation within the dimensions of the clear aperture of the pixel of said SLM.

15. The system of any one of claims 6 to 14, comprising a field MLA accommodated in the focal plane of the focusing MLA such that the optical power of the field MLA is essentially the same as the optical power of the focusing MLA.

16. An imaging method comprising generating a coherent light beam having essentially single local beam direction per point in a beam cross section and spatial coherence in successive cross sections along the beam propagation axis.

17. The method of claim 16, wherein said coherent light beam is produced by emitting coherent light, passing said emitted diverging beam through a beam shaper, and collimating light output from the beam shaper.
